(19) United States
(12) Patent Application Publication
(10) Pub. No.: US 2007/0172574 A1
(43) Pub. Date: Jul. 26, 2007

(54) Cereal flour production process

(76) Inventors: Franco Varvello, Vigevano (IT); Francesca Varvello, Vigevano (IT)

Correspondence Address: DICKSTEIN SHAPIRO LLP, 1825 EYE STREET NW, Washington, DC, 20006-5403, US

(21) Appl. No.: 10/580,262

(22) PCT Filed: Dec. 12, 2003
(86) PCT No.: PCT/IB03/05895

§ 371 Date: Jan. 10, 2007

(51) Int. Cl. A21D 2/00

(52) U.S. Cl. 426/622

(57) ABSTRACT

In a first aspect, the present invention relates to a process for producing a flour enriched with cereal germ, comprising the main stages of the separation of the germ oil from the cereal germ, and the use of said oil in order to enrich the type 0, 00, 1, 2 and wholemeal cereal flours, in such a manner as to obtain a germ oil enriched flour. According to a preferred aspect of the invention, said separation stage of the germ oil from the cereal germ comprises the stage of pressing the cereal germ to give the germ oil and a deoiled germ residue which is milled to give the germ flour. In an additional preferred aspect of the present invention, said process comprises the stage of the mixing of the germ flour with the germ oil enriched flour and with the flour obtained from the milling of the cereals, to give the cereal germ enriched flour. The present invention additionally relates to a product obtainable using said process which is a cereal germ enriched cereal flour.

The present invention relates to a process for the production of cereal flours.

Wheatgerm is known to contain principally vitamin E or α-tocopherol together with other substances such as: B group vitamins, traces of vitamins C, A and D, lecithin, starch, simple sugars, rough fibre, iron, calcium, phosphorous, potassium, magnesium, zinc, manganese, copper, cobalt, selenium, molybdenum, essential polyunsaturated fatty acids (amongst which are linoleic, oleic, linolenic, palmitic, stearic acids) and octosanol. Vitamin E is a natural antioxidant because it reacts with the free radicals present within our system, responsible for the oxidative processes which occur in cells and which contribute towards the rise of some pathologies such as some degenerative diseases of the eyes and of the nervous system, cardiovascular diseases, cancer and ageing of the skin. Vitamin F is constituted by a mixture of essential polyunsaturated fatty acids, mainly linoleic acid (omega-6) and linolenic acid (omega-3). Vitamin F is not synthesised by our system and, therefore, must be introduced through the diet in as much as its function is essential. Indeed, the omega-6 and omega-3 acids are indispensable in the formation of the cellular membrane and in keeping it fluid; they preserve the elasticity of arterial walls; they prevent the depositing of triglycerides and cholesterol within the arteries, preventing atherosclerosis; they foster the integrity of the skin and hair and weight reduction; they stimulate the activities of the internal secretion glands.

Finally, octosanol, a long chain lipid alcohol, has a marked effect on physical stamina, on muscle glycogen, on the cellular use of oxygen and contributes towards the breakdown of the toxins produced from lactic acid. It is, therefore, recommended for those under stress, during periods of intense work, for those suffering from psycho-physical exhaustion and for those participating in sports.

Wheatgerm is, therefore, a complete nourishment which provides a series of substances which are essential for the good functioning and the health of our bodies. In the past, wholemeal flour, obtained from the milling of the whole grain, including the germ, was used in the daily diet. Currently, wholemeal flour, obtained from the milling of the whole grain, is hardly used due to its poor preservability. Instead, type 0, 00, 1, 2 and “wholemeal” flours are used which are obtained from the milling of just the endocarp (the innermost part of the seed) and contain almost exclusively starch and are, therefore, low in protein, mineral salts, vitamins and fibre. Thus, it is essential to supplement our daily diet with the very important elements which are contained within wheatgerm and also within the germ of other cereals. This problem is resolved by the present invention which illustrates a process which allows the enrichment of cereal flours with cereal germ. Indeed, these flours preserve the exact characteristics of colour and flavour of the type 0, 00, 1 and 2 flours but also contain the cereal germ which is the principal source of the essential elements for the health and the good functioning of the human body.

In a first aspect, the present invention relates to a process for producing a flour enriched with cereal germ, comprising the stages of the separation of the germ oil from the cereal germ, and the use of said oil in order to enrich the cereal flour, in such a manner as to obtain a flour enriched with germ oil.

According to a preferred aspect of the invention, said separation stage of the germ oil from the cereal germ comprises the stage of pressing the cereal germ to give the germ oil and a deoiled germ residue which is milled to give the germ flour.

In an additional preferred aspect of the present invention, said process comprises the stage of the mixing of the germ flour with the germ oil enriched flour and with the flour obtained from the milling of the cereals, to give the cereal germ enriched flour.

Further characteristics and advantages of the enrichment process of the type 0, 00, 1, 2 and wholemeal cereal flours with wheatgerm, according to the present invention, will be understood mostly from the description of an example, given below as a non-limiting indication, with reference to the following figure:

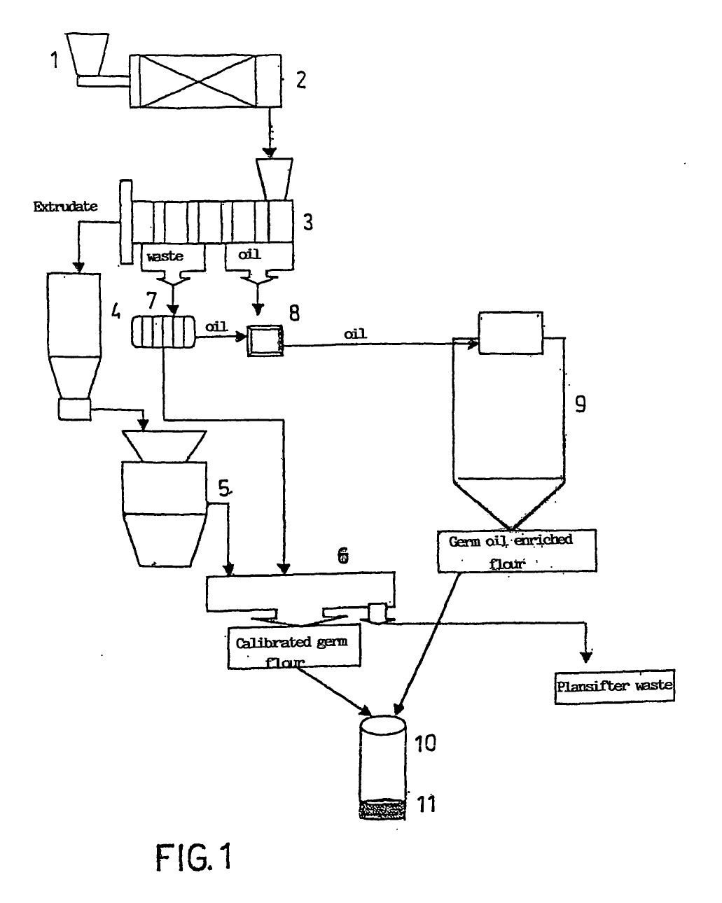

FIG. 1 represents a diagrammatic view of the plant for the execution of the above cited process.

The germ is collected in the collecting hopper 1; the capacity of the plant may be, for example, 80 kg/hour. From the hopper, the germ is inserted into the drier 2 where it is heated to a temperature between 30° C. and 60° C., preferably about 30° C. The germ comes into contact with the walls of the heating container for an amount of time between 2 and 15 minutes, preferably for about 3 minutes, reaching a final temperature between 30° C. and 60° C., preferably about 33° C. This operation is needed in order to reduce the percentage of water present within the germ, thus improving the oil extraction process. Upon exit, the germ has a humidity between 2% and 10%, with the loss of 3-11 percentage points, preferably about 8% with a loss of 4-5 percentage points. Preferably, the heating of the germ takes place in a cylinder equipped with rotating infrared ray lamps.

The dried germ is inserted into the press 3, preferably a horizontal press, which allows the separation of the germ oil from the germ with the attainment of a deoiled germ residue and oil impregnated process wastes. Said pressing takes place at a temperature between 70° C. and 100° C., preferably between 90° C. and 95° C., more preferably about 91.5° C. Said oil impregnated process wastes constitute from 1% to 6% by weight of the total germ, preferably about 3% by weight, and the starting product passes into the press within an interval of time between 20 and 60 seconds, preferably in about 30 seconds.

The deoiled germ residue is then inserted into the grain crusher 4 preferably in extruded form and is milled by means of a blender, until achieving an ideal granulometry for being milled in a stone mill, as known to the experts in the art. The crushed product is then introduced into the stone mill 5 and, afterwards, sent into the plansifter 6 where the selection of the germ flour occurs by calibration, i.e. the separation from any possible particulate impurities.

At the same time, the process wastes are squeezed in the press 7, in order to extract the residual oil, which is sent to the filter-press 8, which is necessary in order to separate any possible residues present within the oil. Preferably the squeezing of the wastes is carried out with a seed squeezer and dicer.

The deoiled wastes are passed into the plansifter 6 and then mixed with the germ flour, in quantities between 1% and 6% by weight (with respect to the germ flour), preferably in quantities of about 3% by weight, in order to obtain the calibrated germ flour.

Following filtration, the germ oil is used in order to enrich the type 0, 00, 1, 2 and wholemeal flours, obtained from the grinding of the cereals. Said enrichment is carried out by using the atomiser 9 constituted by a nebulisation system which nebulises the oil in such a manner as to maximise the contact surface with the flour. The germ oil enriched flour is thus obtained. Preferably, the germ oil is mixed with the flour in the atomiser, in quantities between 3% and 20% by weight, more preferably in quantities of about 10%. Finally, the calibrated germ flour and the germ oil enriched flour are pre-mixed in the container 10 in proportions between 1:1 and 5:1, preferably in the proportion of 2:1, and then combined with the flour obtained from the milling of the cereals, in the batch feeder 11, in quantities between 1% and 6% by weight, preferably in quantities of about 1.5% by weight, in order to give the finished product i.e. the cereal germ enriched cereal flour. Preferably, said finished product is wheatgerm enriched type 0, 00, 1, 2 and wholemeal tender wheat flour.

In a second aspect, the present invention refers to a product, obtainable through the aforecited process, which is a cereal flour, said cereals are selected from soft wheat, hard wheat, rice, maize, barley, oats, rye, millet, sorgum, and/or mixtures thereof, enriched with cereal germ, said cereals are selected from soft wheat, hard wheat, rice, maize, barley, oats, rye, millet, sorgum, and/or mixtures thereof, more preferably it is soft wheat flour, preferably of the type 0, 00, 1, 2 and wholemeal, enriched with wheatgerm. In a third aspect, the present invention refers to oven-baked products, for example bread, breadsticks, crackers etc., prepared with a flour obtained according to the process of the present invention.

The process according to the present invention allows the attainment of cereal flours which are enriched from the nutritional point of view, thanks to the presence of cereal germ, which keep well over the long term without giving rise to rancidation phenomena. Furthermore, these flours have a pale white/yellow colour, and so are therefore very similar to the flours currently on the market, but possess superior organolectic qualities (e.g.: improved taste and improved aroma). These flours allow the attainment of improved doughs from the reologic and raising point of view, in as much as the substances contained within the cereal germ constitute an essential nutrient for the micro-organisms responsible for the raising process. It follows that the oven-baked products obtained with this flour are more flavoursome, softer and keep better over time.

1. A process for producing a flour enriched with cereal germ comprising the stages of:
a) separation of the germ oil from the cereal germ;
b) enrichment of the flour obtained from the milling of the cereals with the oil from step a), in order to give the flour enriched with cereal germ oil.

2. The process according to claim 1, wherein said stage a) of the separation of the germ oil from the cereal germ comprises the stages of:
a₁) squeezing the cereal germ in order to give germ oil and a deoiled germ residue;
a₂) milling said deoiled germ residue in order to give germ flour.

3. The process according to claims 1 or 2 further comprising the stage of:
c) mixing the germ flour with the germ oil enriched flour and with the flour obtained from the milling of the cereals, to give cereal germ enriched flour.

4. The process according to any of the claims 1 to 3 wherein said squeezing of cereal germ (step a₁)), comprises a drying stage of the cereal germ, preferably at a temperature between 30° C. and 60° C.

5. The process according to claim 4, wherein said drying stage of the cereal germ is carried out at a temperature of about 30° C.

6. The process according to claim 5 wherein said drying stage is carried out in a rotating cylinder equipped with infrared ray lamps (2).

7. The process according to any of the claims 4 to 6, wherein said drying stage has a duration between 2 and 15 minutes.

8. The process according to claim 7, wherein said drying stage has a duration of about 3 minutes.

9. The process according to any of the claims 4 to 8 wherein, in said drying stage, the germ reaches a final temperature between 30° C. and 60° C.

10. The process according to any of the claims 4 to 9 wherein, in said drying stage, the germ reaches a final temperature of about 33° C.

11. The process according to any of the claims 4 to 10 wherein the germ, upon emerging from said drying stage, has a humidity between 2% and 10%.

12. The process according to any of the claims 4 to 11 wherein the germ, upon emerging from said drying stage, has a humidity of about 8%.

13. The process according to any of the claims 2 to 12 wherein said squeezing of the cereal germ (step a₁)), comprises a pressing stage.

14. The process according to claim 13, wherein said pressing stage is carried out in a horizontal press (3).

15. The process according to claims 13 or 14 wherein said pressing stage is carried out at a temperature between 70° C. and 100° C.

16. The process according to any of the claims 13 to 15, wherein said pressing is carried out at a temperature between 90° C. and 95° C., preferably about 91.5° C.

17. The process according to any of the claims 13 to 16 wherein, in said pressing stage, the germ oil is separated from the germ thus obtaining a deoiled germ residue.

18. The process according to claim 17 wherein said deoiled germ residue is in an extruded form.

19. The process according to any of the claims 13 to 18 wherein, in said pressing stage, some of the germ oil impregnated processing wastes are additionally separated.

20. The process according to claim 19 wherein said oil impregnated processing wastes are from 1% to 6% by weight of the total germ.

21. The process according to claim 20 wherein said oil impregnated processing wastes are about 3% by weight of the total germ.

22. The process according to any of the claims 13 to 21 wherein, in said pressing stage, the cereal germ passes into the press (3) within a time interval between 20 and 60 seconds.

23. The process according to claim 22 wherein, in said pressing stage, the cereal germ passes into the press (3) within 30 seconds.

24. The process according to any of the claims 19 to 23 additionally comprising a pressing stage of said wastes for the recovery of germ oil.

25. The process, according to any of the claims 1 to 24, additionally comprising the filtration stage of the germ oil.

26. The process according to claim 25 wherein said germ oil filtration stage comprises the stage of combining the oil obtained according to claim 17 with the oil obtained according to claim 24.

27. The process according to claims 25 or 26 wherein said oil filtration stage is carried out with a filter-press (8).

28. The process according to any of the claims 1 to 27 wherein said enrichment stage (step b)), comprises the stage of the combining of the cereal germ oil with the cereal flour.

29. The process according to any of the claims 1 to 28 wherein said germ oil is combined with said cereal flour in a quantity between 3% and 20% by weight, preferably in a quantity of about 10% by weight.

30. The process, according to claim 28 wherein said combining stage of the germ oil with the flour is carried out in an atomiser (9) for the nebulisation of said germ oil.

31. The process according to any of the claims 2 to 30 wherein said milling stage of the deoiled germ residue, (step a₂)), comprises a crushing stage (4) of said deoiled germ residue.

32. The process according to claim 31 wherein said milling stage of the deoiled germ residue, (step a₂)) additionally comprises a milling stage of said crushed deoiled germ residue with a stone mill (5).

33. The process according to any of the claims 3 to 32, wherein said mixing stage, (step c)), comprises a stage of the selection of the product obtained from the combination of the meal, according to claim 32, with the deoiled wastes, according to claim 24, in a plansifter (6), in order to give a germ flour.

34. The process according to claim 33 wherein, in said mixing stage, the deoiled wastes, according to claim 24, are combined with the meal, according to claim 32, in a quantity between 1% and 6% by weight, preferably in a quantity of about 3% by weight, in order to give the germ flour.

35. The process according to any of the claims 3 to 34 wherein the mixing stage, (step c)), comprises a pre-mixing stage of the germ flour with the germ oil enriched flour in a proportion between 1:1 and 5:1, preferably in a proportion of 2:1.

36. The process according to any of the claims 3 to 35 wherein said mixing stage, (step c)), comprises an additional mixing stage of said flour, obtained according to claim 35, with cereal flour in a quantity between 1% and 6% by weight, preferably in a quantity of about 1.5% by weight.

37. The process according to any of the claims 1 to 36, wherein said cereals are selected from soft wheat, hard wheat, rice, maize, barley, oats, rye, millet, sorgum and/or mixtures thereof.

38. A flour obtainable with the process according to any of the claims 1 to 37.

39. The flour according to claim 38 which is a wheatgerm enriched wheat flour.

40. The flour according to claims 38 or 39 which is a type 0, 00, 1, 2, wholemeal soft wheat flour enriched with wheatgerm.

41. Oven-baked products obtainable with the flour according to any of the claims 38 to 40.
